(19) United States
(12) Patent Application Publication
(10) Pub. No.: US 2002/0161097 A1
(43) Pub. Date: Oct. 31, 2002

(54) Pigment for rotogravure paper

(76) Inventors: John Hen, Macon, GA (US); William Michael Riggin, Midlothian, VA (US)

Correspondence Address: Stephen I. Miller, Engelhard Corporation, 101 Wood Avenue, P.O. Box 770, Iselin, NJ, 08830-0770, US

(21) Appl. No.: 09/792,367

(22) Filed: Feb. 23, 2001

(51) Int. Cl. C08K 3/34

(52) U.S. Cl. 524/447

(57) ABSTRACT

A mixture of bulked delaminated kaolin and calcined kaolin is used without addition of or substantial reduction in dosage of a titania pigment in a coating for rotogravure paper.

### BACKGROUND OF THE INVENTION

The present invention is directed to kaolin compositions especially useful for improving paper properties such as printability, opacity, and sheet gloss in paper coating applications, particularly for rotogravure papers including lightweight coating (LWC) and ultra lightweight coating (ULWC) papers. In particular, the invention relates to pigments adapted for use in making coated rotogravure paper that permit the reduction or elimination of expensive pigments such as titanium dioxide while unexpectedly providing superior rotogravure printability.

Delaminated kaolin clays such as NUCLAY® kaolin have been traditionally used in paper coating to improve smoothness, ink holdout and coverage. A typical pigment composition for premium coating on lightweight rotogravure paper consists of a blend of mechanically delaminated kaolin clay, a calcined kaolin clay pigment and titanium dioxide. Rotoprinting imposes special burdens on the pigment selection especially when lightweight coatings are used. The present invention provides better or equal optical properties at significantly improved rotoprintability without using titanium oxide, an expensive pigment. The invention makes use of a simple blend of chemically bulked delaminated kaolin clay and calcined kaolin in formulating coatings for these premium grades.

The term “bulking” as applied to pigments is widely used to describe pigments having voids incorporated therein. Among other things, bulking improves the opacification of a pigment and has been utilized to achieve improved rotoprintability. Generally, bulking of kaolin pigments is achieved by thermal or chemical means. A pioneer patent relating to thermal bulking is U.S. Pat. No. 3,586,523, Fanselow et al, assigned to a predecessor of this application. The key feature in '523 was the use of a unique, ultrafine tertiary kaolin referred to as “hard” kaolin to produce a high brightness, low abrasion pigment. The products supplied under the registered trademark ANSILEX 93 is still widely used by the paper industry, both as a filler pigment or as a coating pigment. The fine particle size calcined kaolin has an average particle size of about 0.8 microns. ANSILEX 93 is widely used in roto coating formulations in admixture with mechanically delaminated kaolin and titanium dioxide.

A coating containing ANSILEX 93 as the sole pigment is not used because of its high cost, limitation on coating solids and runnability, abrasiveness, poor paper properties such as low gloss, roughness and poor print gloss.

At about the time the paper industry investigated the use of thermally bulked kaolin in paper coating and filling, it was proposed to chemically bulk kaolin. This avoided the expense of calcination. One approach was to use an oligomer such as hexamethylene diamine. Reference is made to the background sections of U.S. Pat. Nos. 4,943,324 and 5,085,707 Bundy et al. These patents distinguish between paper filling and paper coating application in terms of pigment compositions and performance criteria. Bundy et al '707 presents examples of the use of the surface treated kaolin in coating paper webs for rotogravure pigments. Bundy et al U.S. Pat. No. 4,943,324 is directed to paper filling.

Another class of chemicals used to produce bulked kaolin pigments includes high molecular weight, high charge density organic cationic polymers such as diallyl dimethyl ammonium salts and copolymers of alkylamine and epichlorohydrin. Reference is made to commonly assigned U.S. Pat. No. 4,738,726 Pratt et al. U.S. Pat. No. 4,767,466 Nemeh et al and U.S. Pat. No. 4,772,332 Nemeh et al. These patents disclose the utility of cationically bulked kaolin as a pigment for a paper substrate adopted to be printed by gravure.

U.S. Pat. No. 4,948,664, Brociner, contains an extensive discussion of gravure printing and discloses that pigments having a narrow particle size distribution (including mechanically delaminated kaolin) are especially useful for coating gravure paper. It should be noted that chemical bulking and thermal bulking result in a narrowed particle size distribution.

While it has long been known in the art that bulked kaolin is useful in formulating rotogravure coatings, in commercial practice an expensive titania pigment is traditionally present along with mechanically delaminated in kaolin in commercial formulation where low coat weight, generally less than 8 to 10 g/m², is required and printability, smoothness and cost are also considerations. As shown in the accompanying examples, chemically bulked kaolin with a desired narrow particle size distribution does not provide LWC roto sheets comparable in quality to those based on titania, mechanically delaminated kaolin and calcined kaolin.

### SUMMARY OF THE INVENTION

A blend of a major amount of a chemically bulked delaminated hydrous kaolin and a minor amount of calcined kaolin pigment permits the complete or partial elimination of T₁O₂ (from a control pigment blend consisting of delaminated kaolin clay and T₁O₂) while unexpectedly improving the rotogravure printability and smoothness of coated paper. Chemical bulking is preferably achieved by use of high charge density cationic polymer with hydrous (uncalcined) delaminated kaolin.

The blend composition ranges from a 75/25 bulked hydrous/calcined blend to a 98/2 blend; preferably, the blend ranges from 85/15 to 95/5. The hydrous bulked clay is prepared by either of two processes.

The first process involves:

1. Delamination to a 15-20% delta* at 2 μm.

2. Desliming to 12-17% at 0.3 μm.

3. Bulking with 0.03 to 0.15% by weight of cationic polymer, preferably 0.07 to 0.10%.

*Defined hereinafter

The second process involves:

1. Delamination to a 15-20% delta at 2 μm.

2. Bulking with 0.05 to 0.20% of cationic polymer, preferably 0.07 to 0. 15%.

### DETAILED DESCRIPTION OF PREFERRED EMBODIMENTS OF THE INVENTION

The compositions and methods of this invention relate to kaolin-based pigments which impart improved properties to paper, particularly paper used in rotogravure applications especially LWC (including ULWC) paper. The present invention will become more apparent from the following definitions and accompanying discussion.

Particle size distribution, as herein reported, is based on equivalent spherical diameter (e.s.d.) on a weight basis as measured by conventional sedimentation techniques using the SEDIGRAPH® particle size analyzer supplied by Micromeretics Inc. It should be understood that the measurements of the size of clay particles for an undelaminated kaolin pigment that are 0.3 micrometer or finer are of limited reproducibility. Thus, when a SEDIGRAPH® analyzer is employed, the value for weight percent may be ±5% when tested by another operator or a different SEDIGRAPH® analyzer is employed. The limited reproducibility extends to kaolin clay particle sizes above 0.3 micrometer for a delaminated kaolin pigment. This is stressed here because delaminated pigment is one of several essential features of this invention. Another essential feature of the invention is bulking. Bulking produces structuring of the pigment in a concentrated aqueous slurry of greater than 55% solids as observed in the increased value for Brookfield viscosity (or low shear viscosity). However, in preparation of a pigment sample for SEDIGRAPH® analysis, the clay slurry is diluted to 6% solids and such a dilution for a bulked pigment renders the effect of bulking or structuring between particles not observable.

Delamination as used herein refers to the operation of subjecting the naturally occurring kaolin particle “stacks” or “booklets” in the aqueous clay slurry to shearing force thereby reducing the kaolin stacks to thin platelets. Delamination may be carried out by subjecting an aqueous slurry of stacked kaolin particles to shearing action in a sand grinder, ball or pebble mills, extruders or rotor-stator colloid mills, or other suitable devices. Reference may be made to commonly assigned U.S. Pat. No. 5,645,635, the disclosure of which is hereby incorporated by reference, for a thorough discussion of the process of delamination of kaolin clay.

The term “desliming” as used herein refers to the operation of separating and discarding a percentage of the fine fraction of the kaolin suspension. In each example presented herein, the defining operation was carried out in a centrifuge. The kaolin suspension to be “deslimed” was supplied to the centrifuge and processed therein to separate the suspension into a coarse fraction and a fine fraction. The fine fraction may be discarded in its entirety or only a selected percentage by volume of the fine fraction may be discarded, while the remainder of the fine fraction may be admixed with the coarse fraction for further processing. When discarding the selected percentage of the fine fraction, it is conventional that the percent defining level expressed refers to the volume percentage of the fine fraction which is discarded. For example, desliming to a level of 40 percent means that 40 percent of the fine fraction from the centrifuge was discarded and that the remaining 60 percent of the fine fraction from the centrifuge was admixed with the coarse fraction from the centrifuge for further processing.

The term “bulking” refers to a process by which clay pigments are modified to improve light scatter, which is a property quantifiable as a scattering coefficient, and generally provides a measure of the opacifying power of the pigment. Reference is made to commonly assigned U.S. Pat. Nos. 4,640,716 and 4,738,726, the disclosures of which are incorporated by reference, which include a more complete discussion of bulking and methods and materials (“bulking agents”) useful in preparing bulked pigments.

The term “hydrous” is intended to describe a clay which has not been subjected to calcination, i.e., a temperature at which the basic crystalline structure of the clay becomes altered. In the case of kaolin, maintaining the clay at temperatures under 450° C. will not alter the kaolin's crystalline structure.

Clays suitable for use in this invention include a wide variety of hydrous kaolin clays. While the examples of this invention may exhibit particular particle size distributions, the present invention is not intended to be limited to any particular particle size distribution.

Conventional kaolin clay crudes used as sources of pigment grades of kaolin usually contain about 40 percent to 75 percent by weight of particles finer than 2 micrometers (μm) after removal of grit and coarse impurities. In conventional kaolin processing, the crude is fed into a blunger to separate the kaolin into small particles, that are mixed with water and a primary dispersant to form a clay-water slip or slurry. The primary dispersant can be sodium silicate, sodium polyphosphate or sodium polyacrylate and those known in the art. The amount of dispersing agent used will generally be in the range of from about 0.025 to 0.3% by weight based on the weight of the dry clay. The clay particles treated with primary dispersant has a negative electric charge, that cause them to repel each other when the particles are suspended in water. The clay-water slurry is pumped from the blunger to rake classifiers or hydrocyclones and screens to remove most of the grits and very coarse impurities. The degritted slurry is collected into large, agitated storage tanks and pumped to the processing plant. At the processing plant, the kaolin slurry is collected in large storage tanks at the plant before it is processed.

Generally the kaolin slurry is first scalped which separate the kaolin particles into a coarse and fine fraction through continuous centrifuges. The purpose of this step is to remove remaining grits and very coarse booklets. The fine fraction is the desired intermediate that is subjected to further processing. The degree of scalping is influenced by the desired particle size distribution, rheology and pigment optical properties of the final product. In general, the kaolin slurry is scalped to 70 to 95% finer than 2 μm, preferably to 80 to 90% at 2 μm. Scalping may be performed after other downstream beneficiation or processing steps such as after delamination.

Delamination of the clay is conducted by conventional means such as those described in the above definition of delamination. The degree of delamination in order to obtain the benefits of the present invention will vary to some extent based on such variables as crude clay particle size distribution, source of crude, amounts of fines in the crude and smoothness of the kaolin surface.

However, for a crude clay having a particle size distribution of 50% (by weight) less than 2 μm to 70% less than 2 μm, good results were achieved by delaminating to a 5 to 40% delta at 2 μm, preferably to a 10 to 20% delta at 2 μm. In other words, a “delta” of 5 to 40% refers to increasing the particle size distribution at the 2 μm level by absolute percentage points of 5 to 40% over the undelaminated 2 μm particle size distribution level.

At delamination levels below 5% delta, particle size distribution determinations are of limited reproducibility particularly when using conventional sedimentation particle size distribution techniques. For example, typical sedigraphs have a repeatability of about 4 to 5% at 2 μm so using this technique to measure particle size distribution deltas below 5% is of limited accuracy and value.

At delamination levels above 40%, the rate of particle size distribution delta for all practical purposes levels off and no further delamination benefit is obtained. Therefore it is not practical to aim for a delamination delta above 40%.

In the practice of this invention, scalping is optionally performed before or after delamination, or further downstream to remove the remaining grits and excessively coarse particles. In general, the kaolin slurry is scalped to 70 to 95% finer than 2 μm, preferably to 80 to 90% at 2 μm. The present invention is not intended to be limited to any particular scalping condition.

Desliming of the delaminated clay can be carried out by any of a number of conventional desliming devices or methods such as those listed in the foregoing definition of desliming.

Desliming refers to particle size separation leading to removal of the finest particles in the distribution of particle sizes. The finest particles are generally considered as particles finer than 0.3 μm. Desliming is customarily accomplished by mechanical means. While chemical desliming is an emerging technology, the practice of this invention includes any means of effective removal of very fine particles in a kaolin slurry. An example of chemical removal of fine particles is disclosed in commonly assigned U.S. patent application Ser. No. 08/891,666, filed Jul. 11, 1997, the disclosure of which is incorporated by reference.

Mechanical desliming of a deflocculated aqueous slurry of hydrous kaolin may be performed by using a centrifuge such as a nozzle discharge disc centrifuge or a scroll discharge centrifuge. An example of a commercial unit is a horizontal three-phase centrifuge from Alfa Laval Co. (Greenwood, Ind.). The Alfa Laval centrifuges apply greater much greater “g” forces (in the range of about 3,000 to 10,000 g-forces) than conventional Bird centrifuges. The high speed Alfa Laval centrifuge can effect a sharp separation of kaolin particles finer than about 0.3 microns from larger kaolin particles. In the lab, desliming was accomplished with lower speed centrifuge, the Damon/IEC CU-5000 centrifuge at 2800 rpm and for about 7 to 15 minutes. In general, desliming is carried out to achieve particle size distribution at the 0.3 μm level of 5 to 30%, preferably in the 5 to 20% range.

It is believed that a wide variety of bulking agents may be used in accordance with this invention and meet the desired application particularly regarding rotogravure printing properties. Such bulking agents are referred to as water soluble cationic polyelectrolyte flocculants described, for example, in commonly assigned U.S. Pat. No. 4,738,726, the disclosure of which is incorporated by reference. Cationic polyelectrolytes refer to substances containing macromolecules carrying a large number of cationic changes at the pH of application. Oligomers such as hexamethylene diamine may be employed, but are not preferred.

Suitable polyelectrolytes include quaternary ammonium salt polymers, copolymers of aliphatic secondary amines with epichlorohydrin, poly(quaternary ammonium) polyester salts that contain quaternary nitrogen, polyamines and polyimines such as polyethyleneimines and polyampholytes having a plurality of cationic groups.

A particularly useful group of polyelectrolytes are quaternary ammonium salts. Most preferred are dialkyl, diallyl quaternary ammonium salt polymers which contain alkyl groups of about 1 to 4 carbon atoms, preferably methyl. See Pratt et al, supra.

A dimethyl diallyl quaternary ammonium chloride polymer commercially available under the trademark designation Polymer 261 LV from the Calgon Corporation having a molecular weight estimated to be between 50,000-250,000 has been found particularly useful in the practice of the present invention and has FDA approval (Code 176-170) for aqueous and fatty food use. Many reagents heretofore proposed to bulk clay do not have FDA approval. However, the invention is not limited to Polymer 261 LV.

Another particularly useful group of polyelectrolytes are the polyquarternary amine polymers derived from (i) reaction of secondary amines, such as dialkylamines, and dysfunctional epoxide compounds or precursors thereof or (ii) reaction of a lower dialkylamine (C₁-C₃), a dysfunctional epoxy type reactant (the same as (i) and a third reactant selected from the group consisting of ammonia, primary amines, alkylenediamines of from 2-6 carbon atoms, and polyamines. The group (i) polymers are disclosed in U.S. Pat. No. Re. 28,807 (Panzer et. al.). The entire disclosure of this reissue patent is hereby incorporated by reference herein.

As to the secondary amines which may be used as reactants, these include dimethylamine, diethylamine, dipropylamine, and secondary amines containing mixtures of alkyl groups having 1 to 3 carbon atoms.

A preferred polymer of group (i) is formed from dimethylamine and epichlorohydrin reaction. Such reaction is detailed in Example 1 of the reissue patent.

Suitable commercially available polymers of the group(i) type are sold under the trade names SHARPFLOC® 22, SHARPFLOC® 23, and SHARPFLOC® 24. The molecular weight of these polymers are estimated to be in the range of approximately 2,000-10,000 atomic mass units (amu). The particular molecular weights of these polymers are not critical as long as the polymers remains water soluble or water dispersible.

The group (ii) polymers which may be used in accordance with the invention, may be generically characterized as branched polyquaternary ammonium polymers and are described in detail in U.S. Pat. No. Re. 28,808 (Panzer, et al.). The entire disclosure of this reissue patent is hereby incorporated by reference.

Suitable commercially available polymers of the group (ii) type are sold under the trade names of SHARPFLOC® 25, SHARPFLOC® 26, SHARPFLOC® 27, SHARPFLOC® 28, SHARPFLOC® 29, SHARPFLOC®30, SHARPFLOC® 31, SHARPFLOC® 32, and SHARPFLOC® 33. The molecular weight of these polymers are estimated to range from approximately 20,000 to 500,000 amu. The particular molecular weights of these polymers are not critical as long as the polymers remain water soluble or water dispersible.

The amount of polyelectrolyte employed is carefully controlled to be sufficient to improve the opacity of the clay as a result of forming a bulked (aggregated) structure in which the aggregates are sufficiently strong to survive mechanical forces exerted during manufacture and end use but is carefully limited so as to assure that the product can be formed into a clay-water slurry that has a solids content of at least 55 percent or higher, which slurry has acceptable rheology. As discussed above, while bulking has a strong influence on rheology for a concentrated kaolin slurry, the particle size distribution measured by SEDIGRAPH® analysis does not normally show a significant change from that prior to bulking.

The amount of the cationic polyelectrolyte salt used to treat the kaolin clay may vary with characteristics of the polyelectrolyte including charge density of the polyelectrolyte, the particle size distribution of the clay and solids content of the clay slurry to which the polyelectrolyte is added. Using the presently preferred dimethyldiallyl ammonium salt polyelectrolyte with clay having a medium size in the range of about 0.4 to 0.9 micrometers, preferably 0.5 to 0.7 μm, and having less than 25 percent finer than 0.3 micrometers and adding polyelectrolyte to a previously deflocculated clay-water suspension having a clay solids content of about 15-40 percent by weight, useful amounts range from about 0.02 to about 0.20 percent by weight of the moisture free weight of the clay, most preferably about 0.06 to about 0.12 percent by weight. When insufficient polyelectrolyte is used, the effect on opacity and printability in coating applications may be less than desired. On the other hand, an excessive amount of the polyelectrolyte may impair other desired properties of the clay, especially rheology. The polyelectrolyte, which is water soluble, is added to the slurry as a dilute aqueous solution, e.g., ¼-2 percent concentration on a weight basis, with agitation to achieve good distribution in the slurry. Ambient temperature can be used. It may be advantageous to heat the slurry of clay, solution of polyelectrolyte, or both to about 150° to 180° F.

Satisfactory results have been realized when the cationic polyelectrolyte was added to deflocculated clay suspensions having pH values in the range of 6 to 9. After addition of polyelectrolyte, the suspension is substantially thickened as a result of flocculation. The resulting thickened system is then acidified, typically to a pH below 5, usually pH 3-4, and bleached using conventional clay bleach (hydrosulfite salt such as sodium hydrosulfite) and aged. The bleaches used are usually reductants which reduce any color forming ferric ion constituents to a more water soluble and therefore more easily removable ferrous state. The bleaching agents are added to the clay mineral slurry in an amount in the range of 1 to 15 lb of bleaching agent per ton of dry clay. The such treated clay suspension is dewatered by filtering to a moist filter cake having a solids content of between about 50 to about 60% by weight. The filter cake is then washed to remove soluble material and then fluidized by addition of a secondary dispersing agent, such as tetrasodium pyrophosphate or sodium polyacrylate or a mixture of the two. To remedy possible problems encountered when slurries of this invention are stored or exposed to high temperature during storage, shipment or subjected to moderate shear conditions, additives such as those disclosed in U.S. Pat. Nos. 4,772,332 and 4,767,466 may be beneficially used instead of conventional secondary dispersants like tetrasodium pyrophosphate or sodium polyacrylate.

The chemically bulked kaolin component of this invention may be shipped in slurry or in dry form. Desirably the slurry will have a total solids content of at least 50% solids. Types of additives that may be used with the present invention include those described in U.S. Pat. Nos. 4,772,332 and 4,767,466 the disclosures of which are hereby incorporated by reference. These additives are particularly useful for remedying problems encountered when aqueous slurries containing pigments of this invention are stored or exposed to high temperature during storage, shipment, or use for example when slurries are prepared into coating colors while providing acceptable rheology. The calcined clay slurry is prepared by wetting the clay with water, caustic and dispersant (including, but not limited to sodium silicate, sodium polyphosphate or sodium polyacrylate) and then mixing the clay under high shear such as with a COWLES mixer at 1500 to 3000 rpm. The solids of the slurry can range from 45 to 60%. CMC (carboxyl methyl cellulose) or other thickener is used to bring the slurry Brookfield viscosity in range.

The rheological requirements of pigments of this invention are concerned both with acceptable high solids slurry rheology and coating color rheology. The viscosity of the high solids suspension of the coating pigment must be sufficiently low to permit mixing and pumping. After the binder is incorporated, the resulting coating color must also have suitable viscosity for handling and application to the paper sheet. In addition, it is highly desirable to obtain a coated calendered sheet which has good opacity, gloss, brightness and printability.

The LWC paper normally contains mainly wood (with little or no kraft). Brightness of LWC paper is in the 66-71% range. Basis weight is 51-70 gsm. The basis weight of ULWC is 35-48 gsm. ULWC is highly filled wood containing. Coat weight for LWC paper is 6 to 12 gsm and for ULWC paper coat weight is 4.4 to 5.9 gsm. Coating color employing pigments of this invention can be applied in board where coat weight is 15 to 30 gsm.

Generally, paper makers seek to use clay coating pigments capable of forming high solids clay-water slurries which have a low shear viscosity below 1200 cp, preferably below 800 cp, when measured by the Brookfield viscometer at 20 r.p.m. High shear viscosity for these slurries should be such that they are no more viscous than a slurry having a Hercules endpoint viscosity of 150 r.p.m., preferably 800 r.p.m., using the “A” bob at 16×10⁵ dyne-cm. Those skilled in the art are aware that when using the Hercules viscometer and measuring endpoints of 1100 r.p.m. or higher, endpoint viscosities are reported in units of 10⁵ dyne-cm at 1100 r.p.m.; apparent viscosity decreases as the value for dyne-cm decreases. It is conventional to use the abbreviated term “dyne” in place of 10⁵ dyne-cm. Thus, a “2 dyne” clay slurry is less viscous than a “9 dyne clay” slurry. As used hereinafter the expressions 150 r.p.m. or higher, or 800 r.p.m. or higher, are intended to include lower viscosities such that endpoint measurements are at 1100 r.p.m. and the values are reported as dynes.

Another requirement of pigments of this invention is that of durability to survive the various stages of production and end-use while possessing the capability of being dispersed to form high solids clay-water slurries having acceptable viscosity. The general wet processing scheme typically employed in making pigments of this invention is by adding a bulking agent before filtration, and therefore the filtered pigment is in the filter cake containing the bulked assemblages when the filter cake is “made down” into a fluid slurry. The expressions “make down” and “made down” are conventional in the industry and refer to the preparation of dispersed pigment-water slurries. In some cases, it may be necessary to apply mechanical work to the filter cake to reduce the viscosity to usable values. The pigment must be sufficiently tenacious to survive the mechanical forces during such treatment. Bulking pigments must also be sufficiently stable under the influence of shear to maintain the bulked structure under the high shear rates, such as the high shear rates encountered in pumping high solids clay water slurries in centrifugal pumps. Moreover, the pigment must be capable of being retained when the deflocculated clay water slurry is formed into a coating color using standard makedown equipment. Also, the pigment must survive during the coating application and subsequent calendering. The fragility of the bulked structures obtained by prior art chemical treatments of hydrous clay has limited their commercial use. Generally, a criterion for durability of a bulked structure is the retention of improved opacification after the above-described handling.

In preparing coating colors, conventional binders or mixtures of binders are used with the deflocculated clay slip. For example, useful coating color compositions are obtained by thoroughly mixing with the clay slip from about 5 to about 20 parts by weight binder per 100 parts by weight of polyelectrolyte treated clay. Such a coating color, when used for coating lightweight publication paper, produces a product which has excellent printability, smoothness, opacity, brightness and desired level of sheet gloss.

The term “binder” as used herein refers to those materials known for use in connection with paper pigments, which aid in holding the pigment particles together and, in turn, holding the coating to the paper surface. Such materials include, for example, casein, soybean proteins, starches (dextrins, oxidized starches, enzyme-converted starches, hydroxylated starches), animal glue, polyvinyl alcohol, rubber latices, styrene-butadiene copolymer latex and synthetic polymeric resin emulsions such as derived from acrylic and vinyl acetates. When the binder comprises a starch which is jet cooked in the presence of added bulking pigment, it may be desirable to heat the slurry of clay into which the polyelectrolyte is added during preparation of the bulking pigment in order to avoid the development of extremely viscous, unworkable coating colors. Temperatures in the range of about 150°-200° F. are recommended. A temperature of about 180° F. has been used with success. However, use of heat during preparation may decrease the scattering ability of the pigment.

The coating color compositions prepared in accordance with the present invention can be applied to paper sheets in a conventional manner. The bulked pigment may be used alone or blended with a known coating clay or other pigments to improve optical and printing properties of the coated paper sheet. The binders and additives used in the coating color are those typically used in the industry and are known to those skilled in the art.

The chemically bulked hydrous kaolin referred to as X-5453 in the examples was prepared from a deflocculated aqueous suspension of Georgia kaolin clay. The deflocculating agent was sodium silicate. Solids content was about 29%. The particle size distribution of the clay in the deflocculated aqueous suspensions was 68% less than 2.0 micrometers, 0.76 micrometers median diameter and 22% less than 0.3 micrometers diameter. The suspension was further deflocculated with 2 lbs./ton of sodium polyacrylate and delaminated to a particle size distribution of 15-20 percent delta at 2 μm in a 5-gallon wet grinder using a 1 to 1 volume ratio of glass beads to pigment suspension. The particle size distribution of the delaminated suspension was 85.8% less than 2 micrometers, 0.55 micrometers median diameter and 25.9% less than 0.3 micrometers diameter. The delaminated suspension was then fractionated in a centrifuge (Damon/TEC CU-5000 Centrifuge) to yield an overflow suspension with particle size distribution of 87.9% less than 2.0 micrometers, 0.50 micrometers median diameter and 28.3% less than 0.3 micrometers diameter. The resulting suspension was passed through a magnetic separator magnet (Carpco-CC WHRMS 3×4L) to achieve above 83 brightness, actual brightness was 83.4. The suspension was deslimed by centrifugation with a Damon/TEC CU-5000 centrifuge to obtain an underflow suspension with particle size distribution of 84.0% less than 2.0 micrometers, 0.66 micrometers median diameter and 16.2% less than 0.3 micrometers diameter.

The deslimed intermediate was diluted to 20% solids and bulked with 1.6 lbs./ton (0.08%) of polydimethyldiallyl ammonium chloride (polydadmac). Addition of polydadmac flocced the suspension. Further floccing was accomplished by lowering the pH to about 3.5 with sulfuric acid. In addition, 10 lbs./ton of sodium hydrosulfite was added as bleach. The resulting dilute suspension was aged, pan-filtered and rinsed with at least an equal volume of clean water to remove water soluble salts. The rinsed filter cake was redispersed with a special dispersant stabilizer additive package sufficient to raise the pH to about 6.5 to 7.0.

The special dispersant package used is a mixture of sodium ligno-sulfonate, partially neutralized polyacrylic acid, pentasodium salt of aminotri(methylenephosphonic acid) and caustic and commercially available under the tradename Colloid 235 (“C-235”) from Vinings Industries, Inc. Variations of the special dispersant package is disclosed in U.S. Pat. No. 4,772,332 the disclosure being incorporated by reference. Portions of this redispersed suspension were spray dried and then added back to the suspension to raise the solids to about 61 to 62% total solids. The resulting suspension was designated X-5453.

The physical properties of X-5453 and the calcined kaolin (ANSILEX 93) as well as the rheology of their pigment slurries are given in Table 1.

TABLE 1
Pigment Properties

| | X-5453 | ANSILEX 93 |
|---|---|---|
| GE Brightness | 86.5 | 92.5-93.5 |
| Sedigraph Avg. Particle | 0.63 | 0.8 |
| Size (μm) | | |
| % at 2 μm | 89 | 88 |
| % at 1 μm | 70 | 65 |
| % at 0.3 μm | 14 | 4 |
| Slurry - % Total Solids | 61.4 | 50 |
| pH | 7.0 | 7.0 |
| Brookfield 20 rpm (cps)¹ | 590 | 350 |
| Hercules A Bob² | 15.7 dynes | 650 rpm @ |
| 1100 rpm | | 16 dynes |

Notes:
¹Brookfield viscosity measured by TAPPI T648-om-88.
²Hercules viscosity as measured in U.S. Pat. No. 4,738,726.

### EXAMPLES OF THE INVENTION

### Example 1

X5453, a bulked delaminated deslimed clay prepared as described above was studied in blends with ANSILEX 93 calcined clay and titanium dioxide. As mentioned, X5453 was bulked with 1.6 #/ton of polydimethydiallyl ammonium chloride (POLYDADMAC). The six blends with X5453 are summarized in Table 2. A 85/5/10 blend of standard delaminated like NUCLAY, TiO2 and ANSILEX 93 was included as a control pigment. The pigments were formulated into generic LWC coating with the following composition added in the order listed.

100 dry parts of pigments in slurry form

2 parts of starch (FG280-hydroxyethyl ether derivative of cornstarch)

6 parts of styrene butadiene latex (SNAP 2048)

0.8 part of calcium stearate (NOPCOTE C-104)

The pH of coating color was adjusted to pH 8.0 with base and the color solids was 57%. The coating color was applied to an LWC basestock using CLC coater (a high speed pilot batch coater). Coat weight was 5.0 lb/3300 sq.ft. The sheets were conditioned at 50% relative humidity and 72° F. and were calendered on a lab soft-nip calender. The roll temperature, pressure and number of passes required for the control coating to achieve a gloss target of 45 to 47 were determined. All other sheets were calendered at the same pressure, temperature and number of nips as the control.

The following tests were performed on the coated papers: TAPPI 75 gloss (T480 om-85), TAPPI Opacity (T425 om-91), TAPPI (GE) Brightness (T646 om-86), Parker Print Surf (at 5 and 10 KgF/cm) (ISO 8791/4 and TAPPI T5555) and Heliotest (rotoprintability test).

In the Helio test, the coated sheet is printed with a gravure cylinder, which has a pattern of ink holding cavities that decrease in diameter from one end to the other. Thus, the test print has large dots at one end and small ones at the other. Skipped dots are counted starting at the large-dot end, and the print quality is reported as the distance in millimeters from the start of the test print to the 20% missing dot. For a given coat weight, the longer the distance in millimeters the better the printability of the coated paper.

TABLE 2
Properties of Sheet Coated with Pigment Blends

| | 1 | | | | | | |
|---|---|---|---|---|---|---|---|
| | (control) | 2 | 3 | 4 | 5 | 6 | 7 |
| NUCLAY | 85.0 | — | — | — | — | — | — |
| X-5453 | — | 85.0 | 87.5 | 90.0 | 95.0 | 90.0 | 100.0 |
| TiO₂ | 5.0 | 5.0 | 2.5 | 5.0 | 5.0 | — | — |
| ANSILEX 93 | 10.0 | 10.0 | 10.0 | 5.0 | — | 10.0 | — |
| Sheet | | | | | | | |
| Gloss (%) | | | | | | | |
| 75° | 47 | 48 | 49 | 51 | 49 | 47 | 44 |
| GE | 72.2 | 74.8 | 74.2 | 74.4 | 73.3 | 72.7 | 71.1 |
| Brightness (%) | | | | | | | |
| TAPPI | 84.4 | 86.5 | 86.0 | 86.0 | 85.6 | 84.9 | 83.4 |
| Opacity (%) | | | | | | | |
| Heliotest | 65 | 84 | 84 | 79 | 71 | 83 | 69 |
| PPS | | | | | | | |
| 5 Kgf/cm² | 1.31 | 1.14 | 1.10 | 1.14 | 1.21 | 1.15 | 1.31 |
| 10 Kgf/cm³ | 0.91 | 0.81 | 0.73 | 0.79 | 0.84 | 0.80 | 0.91 |

Data for 1 and 2 of Table 2 indicate that by replacing all 85 parts of NUCLAY hydrous delaminated clay with X5453, a bulked delaminated clay, marked improvements in helio printability, smoothness (from the lower PPS readings), brightness and opacity are observed. Both 1 and 2 contains 5 parts of TiO₂ and 10 parts of ANSILEX 93.

In 3, the TiO₂ component is reduced to half that in composition 2 and the difference is made up with X5453. For the purpose of this invention, reductions in TiO₂ and calcined clay are made up by an increase in the bulked delaminated clay X5453. All reductions in TiO₂ and calcined clay are referenced to composition 2. In 4, the ANSILEX 93 is reduced to half. Such reductions in TiO₂ and ANSILEX 93 reduced the brightness and opacity slightly compared to composition 2, but did not change the desirable helio printability and smoothness. Thus, these properties are markedly improved for 3 and 4 over the control pigment blend with 85/5/10 NUCLAY/TiO₂/ANSILEX 93.

In composition 5, all 10 parts of ANSILEX 93 are removed. This resulted in a marked reduction in helio printability to similar levels as the control. Smoothness, brightness and opacity are still better than the control.

In composition 7 where all TiO₂ and ANSILEX 93 are eliminated, helio printability and smoothness are equal to (and as poor as) the control but brightness, opacity and sheet gloss are significantly inferior.

In 6 all the TiO₂ is eliminated. Composition 6 consists of 90 parts of X5453 and 10 parts of ANSILEX 93. Unexpectedly, helio printability and smoothness are markedly improved over the control while brightness and opacity are slightly improved. The surprising improvement in helio printability is achieved by a blend of bulked delaminated clay and calcined clay. Such a blend permitted the complete removal of the expensive TiO₂ from the control formulation while achieving equivalent coated sheet properties and superior rotogravure printability and smoothness.

### Example 2

A separate study was conducted employing blends of X5453 and calcined clay. The control was an 88/12 blend of NUCLAY delaminated clay and calcined clay. The pigments were formulated into a coating color with the following composition.

100 parts of pigments

6 parts of styrene butadiene latex

0.8 part of calcium stearate

0.8 part of a viscosity modifier

The pH of the coating color was adjusted to a 8.5 with base and the color solids was 57%. The coating color was applied to an LWC basestock using the CLC coater. Coat weight was 5.0 lb/3300 sq.ft. The same conditioning was used as in example 1. The data are summarized in Table 3.

TABLE 3

| | 8 | 9 | 10 | 11 | 12 |
|---|---|---|---|---|---|
| NUCLAY | 88 | | | | |
| X-5453 | | 88 | 94 | 97 | 100 |
| ANSILEX 93 | 12 | 12 | 6 | 3 | 0 |
| % Sheet Gloss 75° | 56 | 54 | 54 | 56 | 56 |
| Iso Brightness (%) | 70.5 | 72.7 | 72.1 | 72.0 | 71.3 |
| TAPPI Opacity (%) | 85.5 | 87.0 | 86.4 | 86.6 | 86.1 |
| Heliotest | 10 | 61 | 53 | 46 | 43 |
| PPS at 5 Kgf/cm² | 0.99 | 0.81 | 0.84 | 0.85 | 0.83 |
| PPS at 10 Kgf/cm³ | 0.69 | 0.59 | 0.60 | 0.60 | 0.59 |

Comparing compositions 8 (control) and 12, the superior properties of the 100% bulked delaminated kaolin clay X5453 over a blend of NUCLAY and ANSILEX 93 are obvious. Brightness, opacity, heliotest and smoothness are significantly improved. As ANSILEX 93 is added to X5453 containing coating colors, the optical properties and helio printability are further improved. This example illustrates that the excellent properties of the bulk, delaminated X5453 is enhanced by the presence of calcined clay. The enhancement is such that it improves on the properties of a TiO₂ containing color as discussed in Example 1.

### Example 3

This example illustrates the use of an alkylamine epichlorohydrin copolymer in the preparation of the chemically bulked delaminated component of the pigment mixture of this invention.

A crude similar to that used in Example 1 was dispersed 2#/T of sodium polyacrylate (C211) and the crude was delaminated to a 17.2% delta at 2 μm. Delamination was performed at 50% bead volume in a pilot plant at a continuous rate of 5.0 gpm. The sample was centrifuged at the rate of 4.5 gpm to achieve a product with 88% less than 2 μm PSD. The centrifuged product was purified using the Cryo magnet at 1.5 gpm feed rate at a 31.6% feed solids. The purified product was deslimed using the pilot plant Merco to achieve the target PSD (Merco setting was 1.5 gpm and 50 hertz). The sample was diluted to 20.0% TS and bulked with 2.5 #/ton of SHARPFLOC 26 polymer, flocced with sulfuric acid to a 3.5 pH, bleached using 10#/ton of K-Brite. After bleaching, the sample was filtered and rinsed using the pan filters. Redispersion was accomplished with Mayo 148 dispersant package to a pH of 7.4. The suspension was spray dried and slurried.

Physical properties of the bulked slurry

61.1% TS

pH 7.4

pigment brightness 86.2

This bulked slurry would be mixed with a slurry of ANSILEX 93 (50% solids) to a total of about 57 to 60% and formulated with a coating color as in the previous example.

It is within the scope of the invention to dilute the blend of bulked delaminated kaolin and calcined kaolin in the paper coating formulation with minor amounts of known paper coating pigments such as a #1 kaolin, calcium carbonate and mixtures thereof. Preferably such dilution is not practiced. Also, the chemically bulked and thermally bulked pigments can be supplied as spray dried mixture or as a slurry of the spray dried copigment, or as separate slurries to be blended later.

The principles, preferred embodiments, and modes of operating of this invention have been described in the foregoing specification. However, the invention which is intended to be protected herein is not to be construed as limited to the particular forms disclosed, since they are to be regarded as illustrative rather than restrictive. Variations and changes may be made by those skilled in the art without departing from the spirit of the invention.

In claim:

1. A composition useful for coating a paper substrate adapted for rotogravure printing, said composition comprising a physical mixture consisting of a major amount by weight of delaminated kaolin bulked with a cationic polymeric chemical and a minor amount of 25 to 2% by weight of a calcined kaolin pigment.

2. The composition of claim 1 wherein said mixture consists of from 75 to 98% by weight of delaminated kaolin bulked with a cationic polymeric chemical and from 25 to 2% by weight of calcined kaolin pigment.

3. The composition of claim 2 wherein said mixture consists of from 85 to 95% by weight of delaminated kaolin bulked with a cationic polymeric chemical and from 15 to 5% by weight of calcined kaolin pigment.

4. The composition of claim 2 wherein said cationic polymeric chemical is selected from the group consisting of dialkyl quaternary ammonium salts and copolymers of aliphatic secondary amines with epichlorohydrin and poly (quaternary ammonium) polyester salts that contain quaternary nitrogen, polyamines or polyimines.

5. The composition of claim 4 wherein said polymeric chemical is dialkyl, diallyl quaternary ammonium salt group containing 1 to 4 carbon atoms.

6. The composition of claim 1 wherein said delaminated kaolin was deslimed before being bulked with said cationic polymeric chemical.

7. The composition of claim 1 wherein said calcined kaolin pigment is fully calcined.

8. The composition of claim 7 wherein said calcined kaolin pigment has a brightness of at least 90%.

9. The composition of claim 7 wherein said calcined kaolin pigment has a brightness of about 93%.

10. The composition of claim 1 wherein said bulked delaminated kaolin has a brightness of 84 to 90%, an average particle size in the range of 0.45 to 0.75 micron and from 82 to 92% by weight is finer than 2 micron, equivalent spherical diameter and from 10 to 26% by weight is finer than 0.3 micron, equivalent spherical diameter, said mixture consisting from 85 to 95% by weight of delaminated kaolin bulked with a cationic polymeric chemical and from 15 to 5% by weight of calcined kaolin pigment.

11. Rotogravure paper coated with a pigment mixture free from or having a reduced content of titanium oxide, said pigment mixture consisting essentially of from 75 to 98% by weight of a delaminated kaolin bulked with a cationic polymeric chemical and from 25 to 2% by weight of a calcined kaolin pigment.

12. The paper of claim 10 wherein said mixture consists of from 85 to 95% by weight of delaminated kaolin bulked with a cationic polymeric chemical and from 15 to 5% by weight of a calcined kaolin pigment.

13. The paper of claim 11 wherein the cationic polymeric chemical used to bulk the delaminated kaolin is a dialkyl, diallyl quaternary ammonium salt.

14. The paper of claim 11 wherein the cationic polymeric chemical is a copolymer of an aliphatic secondary amine and epichlorohydrin.

15. The paper of claim 11 which has a coat weight in the range of 4.0 to 30 gsm.
